(19) United States
(12) Patent Application Publication
(10) Pub. No.: US 2009/0037227 A1
(43) Pub. Date: Feb. 5, 2009

(54) System and method for providing transferable pre-need funeral services

(76) Inventor: Vanessa Sutton, Atlanta, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/989,669

(22) PCT Filed: Jul. 26, 2006
(86) PCT No.: PCT/US2006/028891

§ 371 Date: Jan. 25, 2008

(51) Int. Cl. G06Q 40/00; G06Q 30/00

(52) U.S. Cl. 705/4; 705/1

(57) ABSTRACT

A system and method for providing a pre-need funeral services that enables a consumer to select a funeral plan and servicing funeral home, within a desired budget, through a website service or associated telephonic system. Following subscription to a service plan, the consumer will be provided with a Pre-need subscription account which funeral plan and other pre-need plans may Be provided. The present system seeks to maintain a database of all purchased Pre-need plans and pre-need planning services including funeral plans and arrangements so as to facilitate servicing funeral home online delivery of pre-need offerings for servicing funeral homes overall profitability and consumers online pre-need planning service through a subscription service method.

Priority based on U.S. Provisional Patent Application Ser. No. 60849197 filed Jul. 28, 2005 and Non-Provisional Patent Application No. 11492724 filed Jul. 25, 2006.

### TECHNICAL FIELD

The present invention relates generally to Pre-need Planning Services, A Pre-need Product and Service, and more specifically to combination insurance risk protection products for various financial protections in a single product while also providing a savings feature as a service through a service plan. A pre-need combination risk protection insurance policy for processing and issuing a claim through subscriptions to a combination risk protection insurance policy for providing transferable pre-need life event services such as life, pension, health, and education services in a single product with a savings feature through subscriptions is also provided. The pre-need combination risk protection insurance policy is a transferable, portable, pre-need or individual policy with a combination of endowment insurance policies with deferred annuities combined with credit life, longevity, asset protection, disability, accidental death and dismemberment, stock option protection, with a group yearly renewable term insurance with a adjustment of income and savings feature, a voluntary pre-need financial savings in a combined trust fund/for investment in pooled investments and or transferable securities.

A Pre-need Product and Service for processing a claim through subscriptions to Pre-need combination risk protection policies (life, health, pension, education and other combination risk protection plans, policies, and trusts.

A Pre-need Financial Service Center for centralized operations of Service Providers (i.e. funeral homes).

### BACKGROUND OF THE INVENTION

The Advance Funeral Planning (Pre-need) specialty in the funeral industry is one of the gateway products for the 50+ financial services market in the 21^{st} century. This is a good opportunity to expand the pre-need offerings in the United States to other pre-need offerings such as pension, health, education and other pre-need plans as a service to consumers. Also, due to cuts in the profit margins at the funeral homes because of caskets being purchased at other locations besides the funeral homes this would generate new revenues for funeral homes and offer consumers a pre-planning service for life events. An opportunity for funeral homes to expand their pre-need market by appealing to two, or three generations of families at the same time thus increasing funeral homes margins and families planning for their future. Also, this is another way to tap the active generations which is the 35 year old and older with pre-need products with savings vehicles to improve the U.S. Capital Markets.

The United States demographics is changing with slowing in U.S. household savings with significant implications for economic growth in the United States and globally. These shifts will change the pension industry. It is now a need for combination risk protection insurance policies in the pension industry with a savings feature which funeral homes could expand their offerings by offering other pre-need products with a savings feature including pension plans to also sustain the United States economic growth.

The United States income security including lower national savings makes it difficult to sustain economic growth in the United States. Therefore, United States households and the United States government will need to increase savings, reduce borrowing, and work to improve the return on U.S. households portfolio's and create 21^{st} century new generation products and services with risk protection features and benefits in a combination product with a savings feature. Also, the declining growth rate of financial wealth accumulation means their will be less household savings to support the fast growing retiree population and more difficult to support domestic investment and to sustain economic growth. The sale of pre-need plans and services would increase funeral homes margins, customers pre-planning and savings, and United States Capital Markets.

Therefore, it is readily apparent that there is a need for a system and method for providing pre-need funeral plans with combination risk protection features and benefits that may be expeditiously subscribed to and implemented; that may be subscribed to via telephone or global networking system services (i.e., remotely); that requires minimal funeral home and/or service provider resources and man-hours; that maintains the desired standard of compassion and professionalism of the servicing funeral home and or service provider, whilst increasing profits; that avoids a consumer advocate approach, yet enables consumers freedom in the selection of a desired funeral home and or service provider and pre-need plan as a service.

### BRIEF SUMMARY OF THE INVENTION

Briefly described, in a preferred embodiment, the present invention overcomes the above-mentioned disadvantages, and meets the recognized need for such an invention by providing a system and method for providing pre-need services and plans as a service with combination risk protection features and benefits (Life Event Insurance Policy) life, health, pension, education, and other combination risk protection features in a single product, pre-need product, transferable and portable being dependent on a funeral home or service provider, group of funeral homes and or group of service providers, funeral merchandise providers or other service providers and having a contractual association with a particular servicing funeral home to provide (competitive and non-competitive with discounts) products, transferable funeral (other) services (services transferable to another funeral home, transferable pre-need combination risk protection insurance policy (third parties). A system and method for providing pre-need services and plans including funeral plans as a service and services that enables online or telephonic selection of a specific pre-need plan inclusive of a funeral plan obligated to servicing funeral home or member merchant organization such as no-employment groups. A pre-need plan Life, pension, health, education, and other transferable, portable pre-need risk protection insurance plan or policy being required to contract with a particular service provider or group of service providers wherein services are transferable and plans as a service is transferable to third parties within a desired budget. A pre-need subscription user account and a pre-need financial services distribution center with a customer service, call center, pre-need bank features being dependent on a service provider (i.e. funeral home), group of service providers (i.e. funeral homes), or merchandise providers (i.e funeral), and having a contractual association with a particular service provider (i.e. servicing funeral home), or group of service providers, (funeral homes), so that customer and service provider are required to contract with a service provider (funeral home) or group of service providers (funeral homes) in order to receive the benefit of pre-planning services and the pre-need financial services distribution center for the centralization of funeral homes or service providers operations in order to streamline operations.

The present invention in its preferred form is a system and method for providing pre-need services and plans inclusive of funeral plans and services with combination risk protection features and benefits in a service plan policy with a pre-need financial services distribution center comprising an online subscription application application with on demand web applications and service provider selection process, service plan/service provider database, telephonic subscription and pre-planning advisory services, subscription pre-need policy issuance, pre-need subscription account process, preneed subscription retrieval and access services, pre-need plan implementation services, service provider financial distribution center. The consumer and service provider is provided with a pre-need subscription account utilized also to subscribe to services and pre-need plans (life, pension, health, education and other transferable pre-need plans with combination risk protection in a single pre-need product with a savings feature to a consumer online contracted with a service provider to offer services by subscriptions and online transactions over the internet. The service provider may access the database for future retrieval of subscribed pre-need services and plans including access to the pre-need policy and payment processes. The service provider can also subscribe to services such as telephonic subscription and pre-planning services, policy retrieval access services, pre-need plans implementation services to offer centralization of service providers (i.e. funeral homes) services to streamline operations and offer new revenue generating techniques for profitability to service providers.

The processes used now for service providers are more decentralized but due to information technology and increased competition globally, this centralized system would offer the pre-need plans as a service through the pre-need plans and insurance service provider by subscription by the service provider with the pre-need financial services distribution center for centralization of service providers operations inclusive of life, health, pension, education and other service providers for owners and managers of service companies to increase profitability.

This system and method eliminates the operational complexities and marketing costs of current pre-need offerings and current decentralized operations in the service industry including the funeral home service industry. The system would include a means for directing the insurance policy proceeds for use as payment for a pre-need subscription policy in which the pre-need subscription policy purchases merchandise all contracted with a particular service provider which the contract is transferable to another service provider and the service plan with combination risk protection features are transferable to third parties. The subscription system, includes a website, a customer service subscription center coupled to the pre-need website, a customer/service provider portal to the pre-need website and an administrator portal to the pre-need website. In one embodiment the contractual relationship will be assigning proceeds to the service provider associated with the combination risk protection transferable insurance policy for payment of the pre-need policy services. The service provider may reassign the proceeds to the pre-need financial service center for payment of merchandise, payment of services, payment of overage or any other services offered through the financial service centralization operation center. The overage paid to the policy holder can be paid directly to them or they may invest in another pre-need plan for pooled investments or transferable securities.

In general, in one aspect, the invention features a method for providing pre-need services and pre-need plans as a service inclusive of a funeral plan through the pre-need funeral and insurance service provider being dependent on a funeral home or service provider, group of funeral homes and or service providers, funeral merchandise providers or other service providers and having a contractual association with a particular service provider and or servicing funeral home to provide (competitive and non-competitive with discounts) products, transferable funeral (other) services (services transferable to another service provider, funeral home, transferable pre-need combination risk protection insurance policy (transferable to third parties) within a desired budget. A pre-need subscription user account and a pre-need financial services distribution center with a customer service, call center, pre-need bank features being dependent on a service provider, or group of service providers, so that customer and service provider are required to contract with a service provider or group of service providers in order to receive the benefit of pre-planning services and the pre-need financial services distribution center for the centralization of service providers (funeral homes) in order to receive the benefit of pre-planning services and benefits of the pre-need financial services distribution center to streamline operations.

The present system seeks to maintain a database of all purchased pre-need services and plans as a service including funeral plans and services and/or pre-need planning services subscribed so as to facilitate a pre-need planning service for consumers contracted with a service provider (i.e. funeral home) through assignment thus increasing profitability and a pre-need financial distribution center to streamline service providers such as funeral homes operations.

During time to perform services, the pre-need subscription system with the pre-need financial services distribution center will facilitate will facilitate arrangements through the service provider and payments of suppliers and service providers including overage to the beneficiary.

In another implementation, the product and service identify a pre-need subscription customer.

In another implementation, the product and services identify a pre-need life, pension, health, and education policy with combination risk protection features in a single product or pre-need product.

In another implementation, the product and service is a transferable, portable pre-need life, pension, health, and education policy; a individual insurance policy with a combination of endowment insurance policies with deferred annuities combined with credit life, longevity, asset preservation, disability, accidental death and dismemberment, stock option protection, other financial protections with a group yearly renewable term insurance with a adjustment of income with a savings feature, (a voluntary pre-need financial savings plan: the combination of risk protection in a single product or pre-need product.

In another implementation wherein the product and service the combination risk protection pre-need transferable portable policy is a pre-need combination risk protection life, health, pension, or education pre-need rider.

In another implementation wherein the product and service combination risk protection pre-need transferable portable policy is a Social Security Administration clients pre-need contract plan rider, which funeral benefits depend on the paid contributions of the policy holder and other federal agencies that fit the criteria for paid contributions.

In another implementation wherein the product and service a combination risk protection pre-need transferable portable policy is long term health care with a pre-need combination risk protection life, health, pension or education pre-need rider.

In another implementation wherein the product and service a combination risk protection pre-need transferable portable policy is a veteran policy with a pre-need combination risk protection life, health, pension or education pre-need rider.

In another implementation wherein the product and service a combination risk protection pre-need transferable portable policy is a life insurance policy with a pre-need combination risk protection life, health, pension or education pre-need rider.

In another implementation wherein the product and service the service provider and/or customer being dependent on service provider, group of service providers, merchandise providers, and having a contractual association with a particular service provider to provide non-competitive and competitive products with discounts, transferable services, transferable combination risk protection insurance, to receive the benefit of pre-planning life event services in conjunction with the pre-need financial service distribution center.

In another implementation the activities related to the pre-need service provider and customer comprise purchasing merchandise.

In another implementation the activities related to the pre-need service provider and customer comprise purchasing services.

Ina another implementation the activities related to the pre-need service provider and customer comprise purchasing insurance.

In another implementation provide the pre-need combination risk protection products and services through memberships to non-employment groups.

In another implementation wherein a online subscription service; a pre-need financial service distribution center to provide a pre-need policy and insurance subscription service and payment to subscription service and service provider.

In another implementation the customer and or service provider subscribe to services and plans as a service.

In another implementation the customer assigns fund proceeds to service provider for payment of merchandise and services.

In another implementation the service provider reassigns fund proceeds to the pre-need financial service distribution center for payment distribution to vendors and other subscribed payment and other services subscribed.

In another implementation the assignment funds deposited in a combined trust fund for pooled investments and/or transferable securities and or other transferable accounts/trust funds.

In another implementation the pre-need financial service distribution center network with a pre-need bank, call center feature for service providers centralization of operations.

These and other features and advantages of the invention will become more apparent to one skilled in the art from the following description and claims when Read in light of the accompanying drawings.

### BRIEF DESCRIPTION OF THE DRAWINGS

The present invention will better understood by reading the Detailed Description of the Preferred and Alternate Embodiments with reference to the accompanying drawing figures, in which like reference numerals denote similar structure and refer to like elements throughout, and in which like reference numerals denoted similar structure and refer to like elements throughout, and in which:

FIG. 1 is a system level flow diagram of a system and method for providing transferable pre-need services and plans as a service;

FIGS. 2A and 2B is a system level flow diagram of a system and method for providing transferable pre-need services and plans as a service;

FIGS. 3A and 3B is a system level flow diagram of a system and method for providing transferable pre-need services and plans as a service;

FIG. 4 is a system level flow diagram of a system and method for providing transferable pre-need services and plans as a service;

FIG. 5 is a system level flow diagram of a system and method for providing transferable pre-need services and plans as a service;

FIG. 6 is a system level flow diagram of a system and method for providing transferable pre-need services and plans as a service;

FIG. 6A is a system level flow diagram of a system and method for providing transferable pre-need services and plans as a service with a pre-need financial service distribution center.

FIG. 7 is an embodiment of a pre-need enrollment form;

FIG. 8 is another embodiment of a pre-need enrollment form;

### DETAILED DESCRIPTION OF THE PREFERRED AND ALTERNATIVE EMBODIMENTS

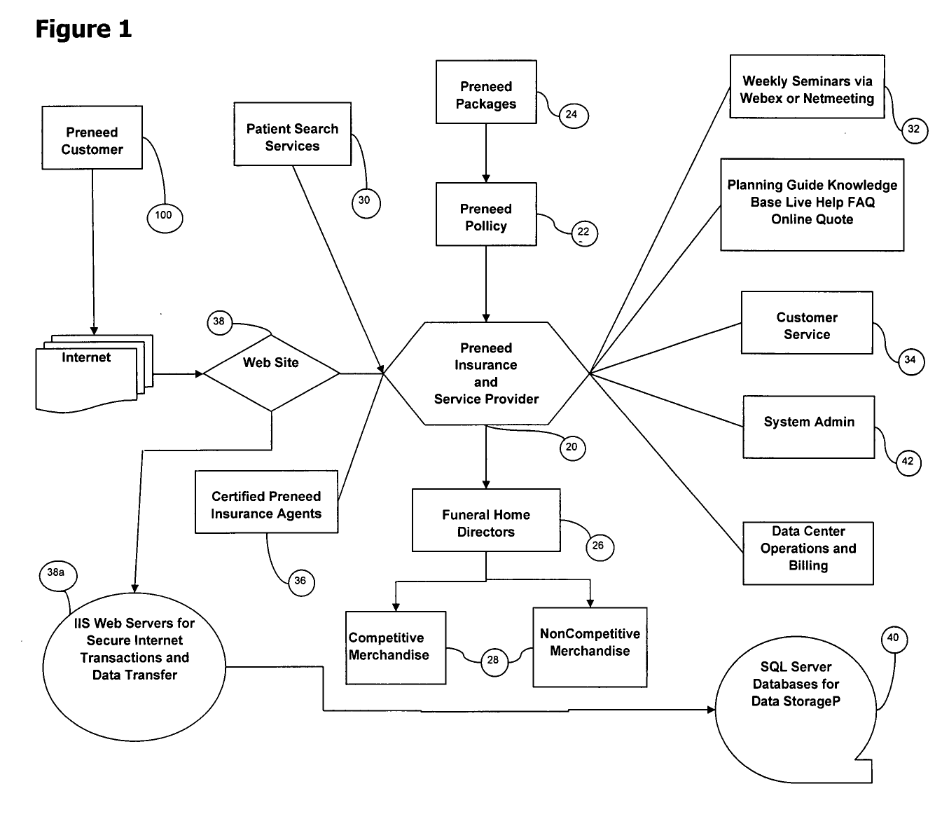

In describing the preferred and alternate embodiments of the present invention, as illustrated in FIGS. 1-6, specific terminology is employed for the sake of clarity. The invention, however, is not intended to be limited to the specific terminology so selected, and it is to be understood that each specific element includes all technical equivalents that operate in a similar manner to accomplish similar functions.

Referring generally now to FIG. 1, the present invention in its preferred embodiment is a system and method 10 for providing pre-need services and plans as a service, wherein the present invention comprises a pre-need insurance service provider 20, wherein subscription service provider 20 provides access to pre-need policy subscription service 22, pre-need package subscription service 24, funeral homes/directors subscription services 26, non-competitive and competitive merchandise 28, patient/policy holder search subscription services and databases 30, educational subscription services 32, customer services 34, certified pre-need insurance agents 36, and subscription service website 38 through which database 40 may be accessed 42. Preferably Subscription service website 38 and database 40 may be accessed by pre-need subscription consumer 100 via a global networking system (e.g., Internet).

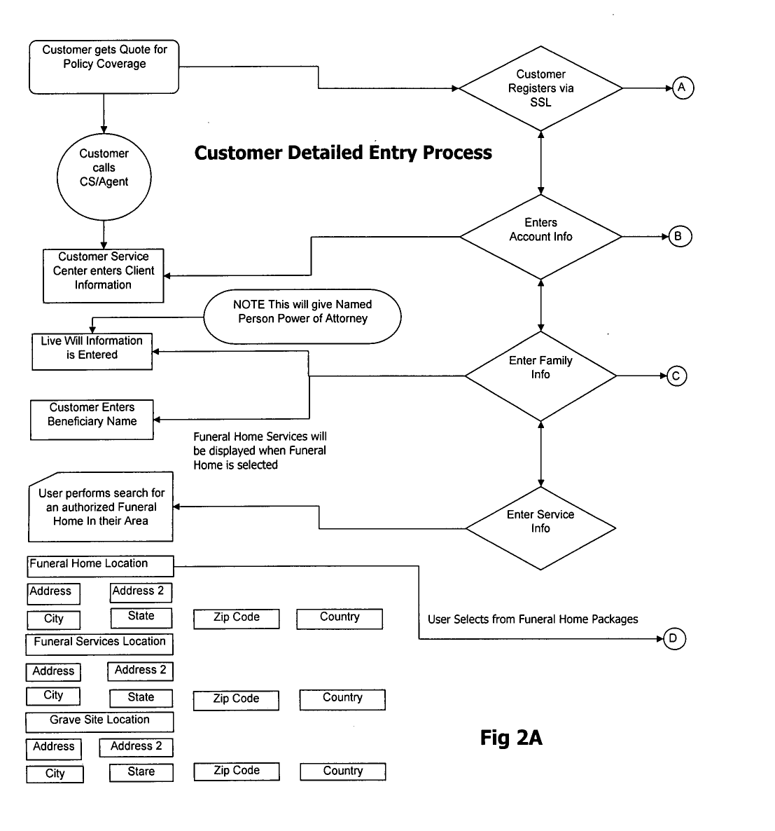

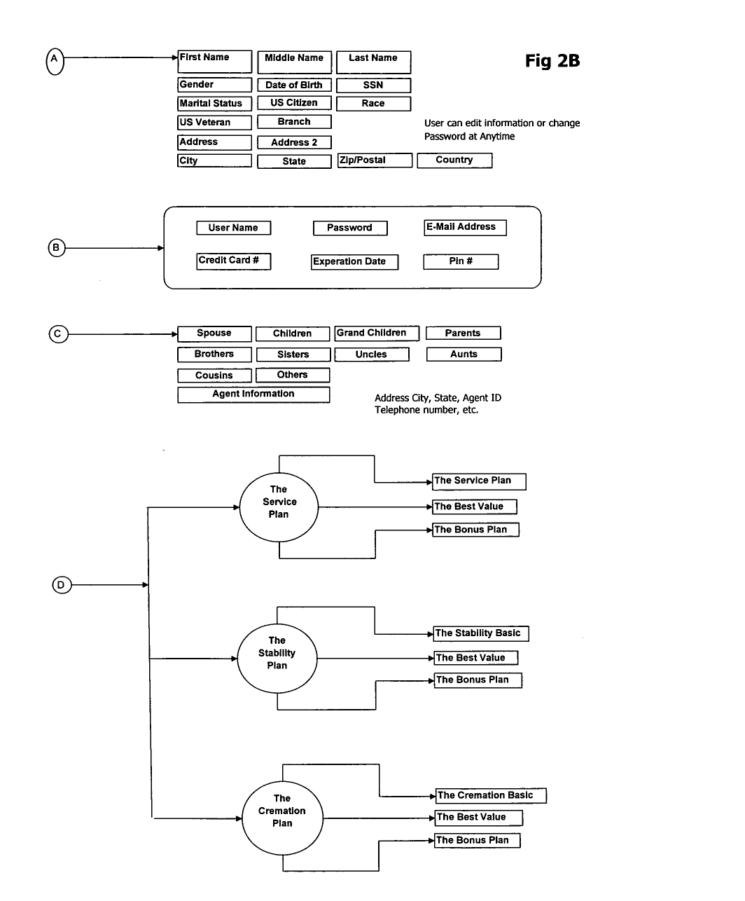

Referring now more specifically to FIG. 2, consumer 100 preferably subscribes to pre-need policies and pre-need packages 24 via website 38 or calling consumer service 34. In either instance, consumer 100 preferably subscribes to pre-need services and plans as a service 22, 24 by providing personal information, such as, for exemplary purposes only, full legal name, gender, date of birth, social security number, marital status, residency and/or citizenship, race, full legal address, will and trust information, named beneficiary information, information pertaining to immediate family members, and the like. In subscribing to pre-need services, and plans as a service, pre-need policies, and pre-need packages 22, 24, consumer 100 is provided with a user account through which consumer 100 may access databases 40 for future retrieval of subscribed pre-need services and plans as a service, pre-need policies, and pre-need packages 22, 24. User account preferably comprises, and may be accessed via entering, username, password, e-mail address, and/or pin numbers, and may further be utilized to enter credit card information for payment of pre-need services and plans as a service, pre-need policies, and pre-need packages.

Through consumer service 34 or website 38, consumer 100 may further explore and select service providers 26, merchandise 28, and educational materials 32 offered under pre-need services and plans as a service, pre-need policies, and pre-need packages. 22, 24. Specifically, through service providers subscription services 26, consumer 100 may select the specific service provider location, where consumer 100 wishes selected services to be performed. 28, consumer may select the desired services. With specific regard to pre-need packages 24, consumer may select from an array of plans as service plan as a service, services, pre-need policies, and pre-need packages under which various service and pre-need policy options are provided.

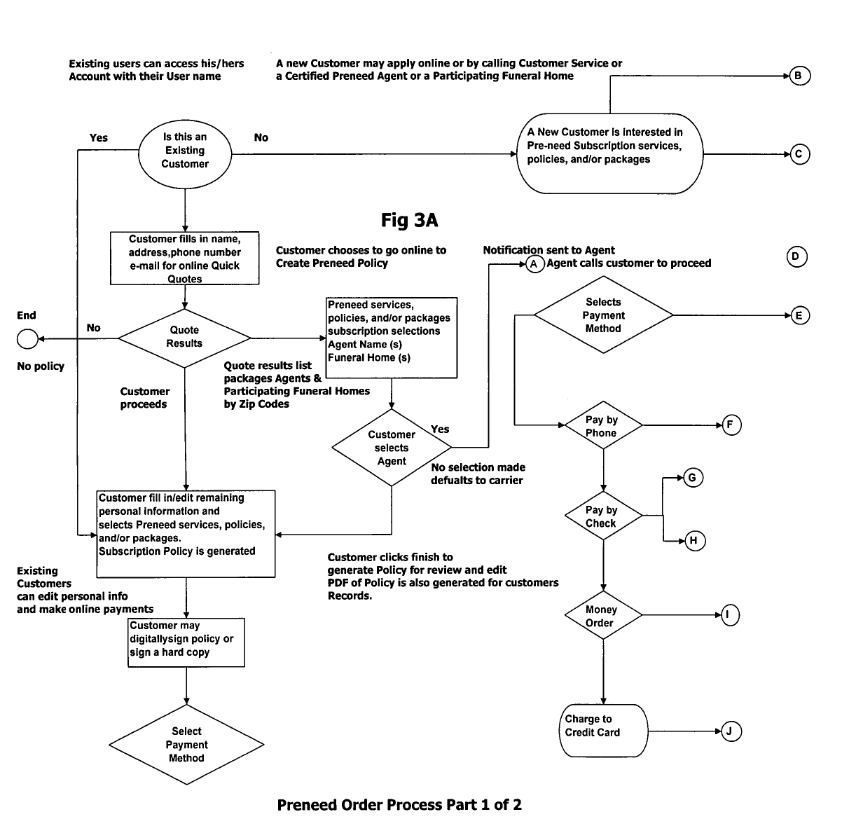

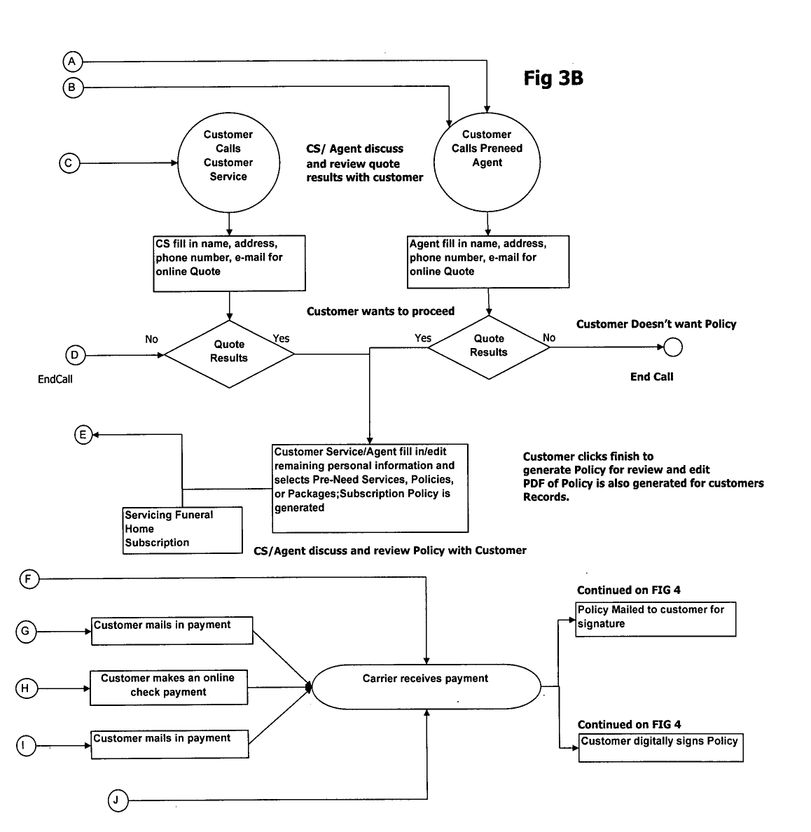

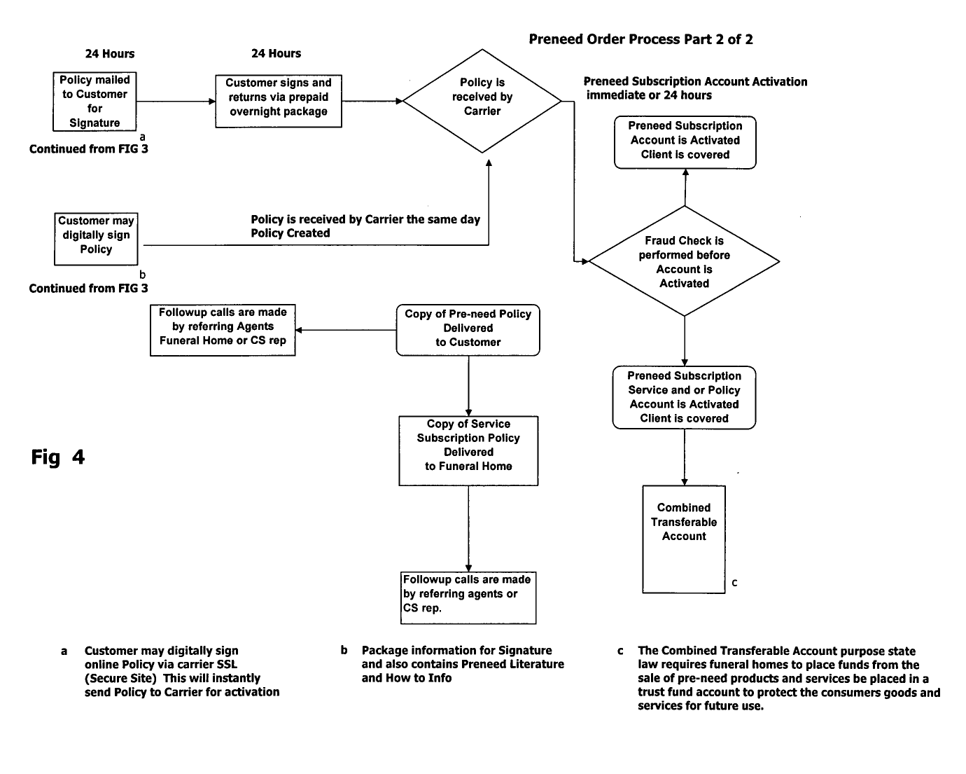

Referring now more specifically to FIG. 3, with continued reference to FIGS. 1-2, all information entered through website 38, and/or provided to certified pre-need insurance agents 36 via consumer service 34, may be modified otherwise changed by consumer 100 at consumer's election. Additionally, through website 38 or consumer service 34, consumer or service provider 100 may effectuate payment for subscription services 222, 24, wherein credit card, check payment information may be supplied via online transactions 38a, or via telephonic transaction with certified pre-need insurance agent 36. Upon payment for the subscribed services or plans as a service 22, 24, consumer 100 is electronically mailed, and hard-mailed, a copy of the pre-need policy and plan.

In general, it is first determined whether or not the customer is an existing subscription customer. If the customer is not existing, then demographic information can be collected and quote for a pre-need policy provided. Pre-need policies and packages are presented to the subscription customer and the customer is further provided with lists of agents, service providers, merchandise providers and the like. Payment plans are identified and executed as discussed further below.

New subscription customer can typically apply over a network, by telephone, through a certified pre-need agent, a participating service provider and the like. If the subscription customer is an existing customer, then the customer can modify the pre-need policies and packages as desired. Existing customer can typically access his/her account with a user name, password, social security number, policy number and the like.

Referring now more specifically to FIG. 4, with continued reference to FIGS. 1-3, upon receipt of the pre-need subscription policy and plan, consumer 100 may digitally sign the electronic version of the policy and/or sign the hard copy of the policy, and forward same to subscription service provider 20 for account activation. Upon receipt of the signed and executed pre-need policy/plan, subscription service provider 20 performs a fraud check prior to activating consumer's 100 account. Wherein satisfaction of the fraud check and implementation of consumer's 100 account, preferably results in consumer 100 being issued a subscription account access and policy/plan retrieval by internet access. Accordingly, consumer 100 may utilize the subscription service account to effectuate any subsequent fees or payments incurred in plan/policy changes and/or access to existing or modified policies/plans.

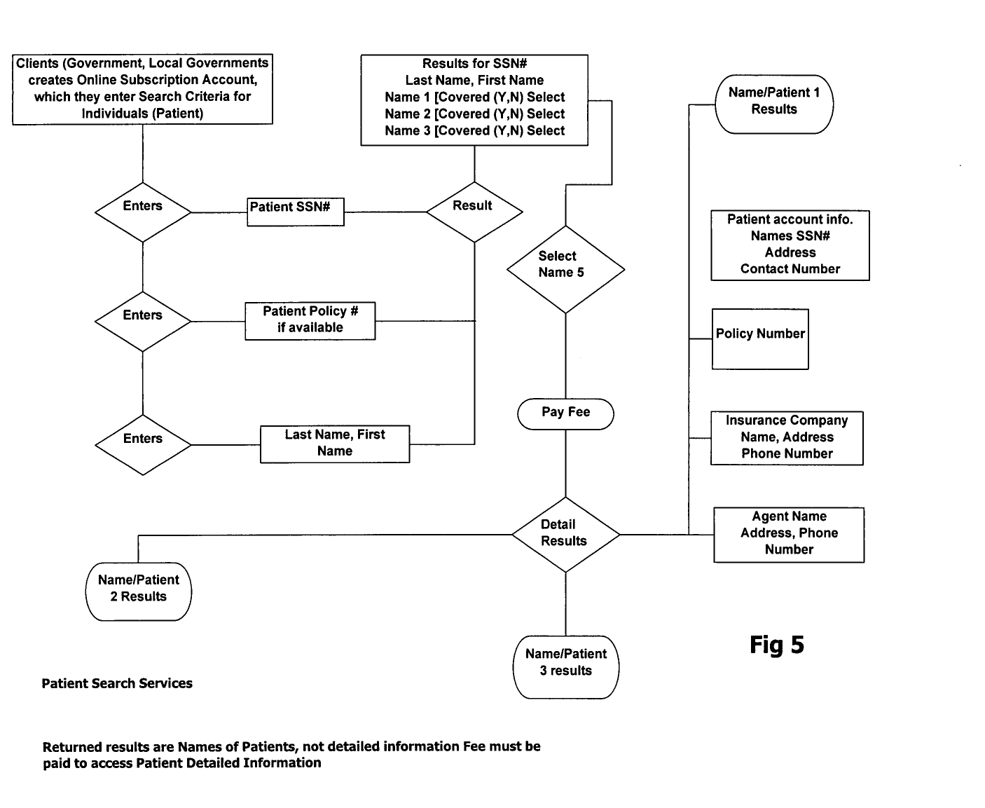

Referring now more specifically to FIG. 5, patient/policy search services 30 enables subscription service provider 20, consumer 100 and other authorized individuals (i.e, government officials and agents) to access pre-need policy/plan information of consumer 100 to facilitate management and determination of plans/services at time of performance. Patient/policy search services 30 may be accessed via website 38 and/or database 40 upon entry of specific patient/consumer 100 information, such as for exemplary purposes only, a Social Security Number, policy/plan number, and/or personal information about consumer 100, wherein detailed results will be provided upon proper authorized entry.

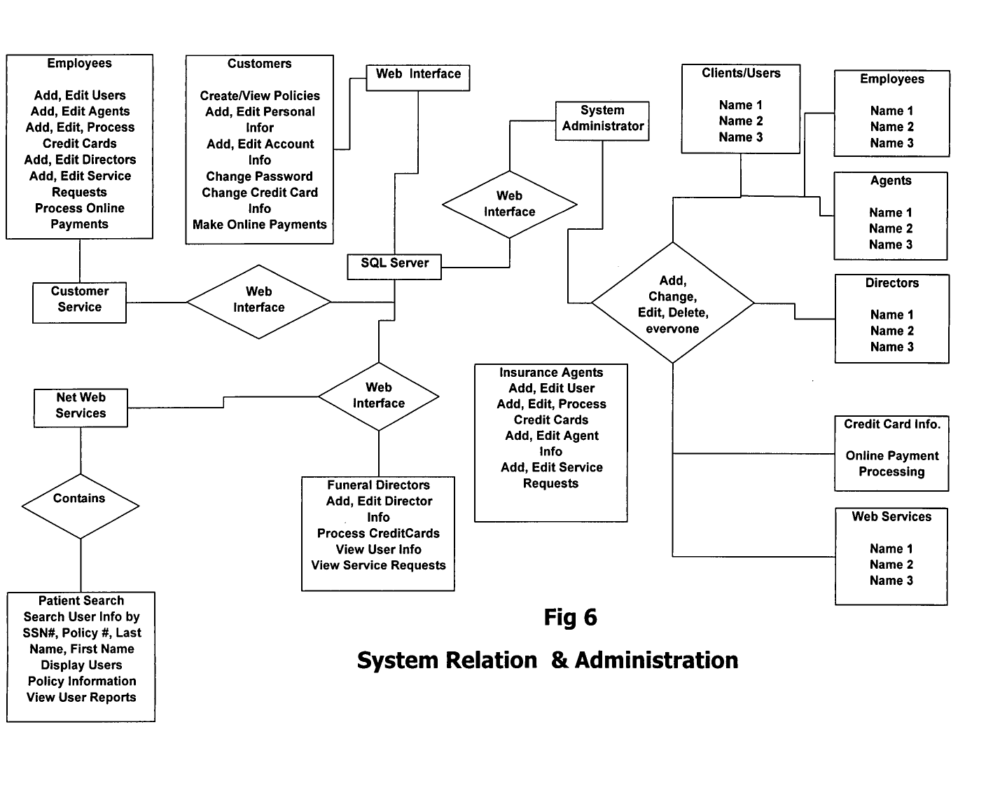

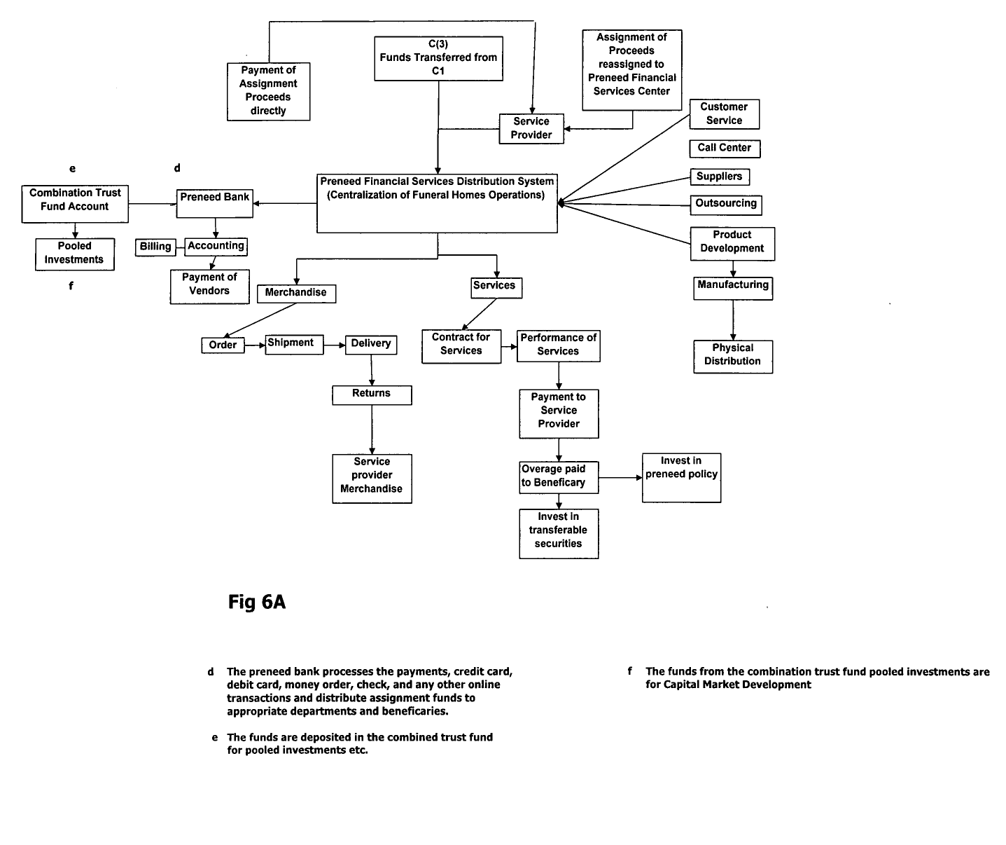

Referring now more specifically to FIG. 6, Subscription service provider 20 may access database 40 via system administrator 42, wherein system administrator 42 enables service provider 20 to manage all aspects relevant to consumer's 100 specific pre-need subscription service 2, 24. Such management includes viewing, emailing and printing policy or ID cards, checking billing status and online payments, viewing account activity, viewing detailed coverage information, checking claim status, adding or deleting users, beneficiaries, agents, representatives, service providers and/or altering provider services and plans as a service, and processing payments.

In general, system 10 can include several security layers that can be changed per customer. Customer are typically assigned separate logins and passwords. Customers can view, use e-mail, print policies and identification cards, check billing status and make online payments, view account activity, view detailed coverage information, and check claim status. At an administration level, the administrator can create view, use email, print policies and identification cards related to a customer, check billing status and make online payments for a customer, view account activity for a customer, view detailed coverage information for a customer, and check claim status for a customer. Administrators can also add or delete users, agents, representatives, directors, and service representatives. Customer subscription service representatives can further create, view, use e-mail, print policies and identification cards related to a subscription customer, check billing status and make online payments for a customer, view account activity for a customer, view detailed coverage information for a customer, and check claim status for a customer. As discussed above, agents and service providers can also have access to the system. Specifically agents and service providers, or other related certified subscription services providers can view, use email, print policies and identification cards related to a subscription customer, view account activity for customer, view detailed coverage information for a customer, and check claim status for a customer.

Now, Referring more specifically to FIG. 6A a system and method for providing pre-need services and plans as a service contracted with a service provider through A pre-need financial services distribution center. The products and services distributed being dependent on a service provider, group of providers, merchandise providers and having a contractual association with a particular service provider to provide products, transferable services, transferable combination risk protection policies as a subscription customer. The contract and funds will be assigned to the service provider in which payment from the combined private insurance trust will be made to the service provider directly and they pay vendors or the contract can be reassigned and the pre-need financial service center can pay vendors, pay for services, process payments, outsource goods and services an any other processes for the streamlining of service providers operations.

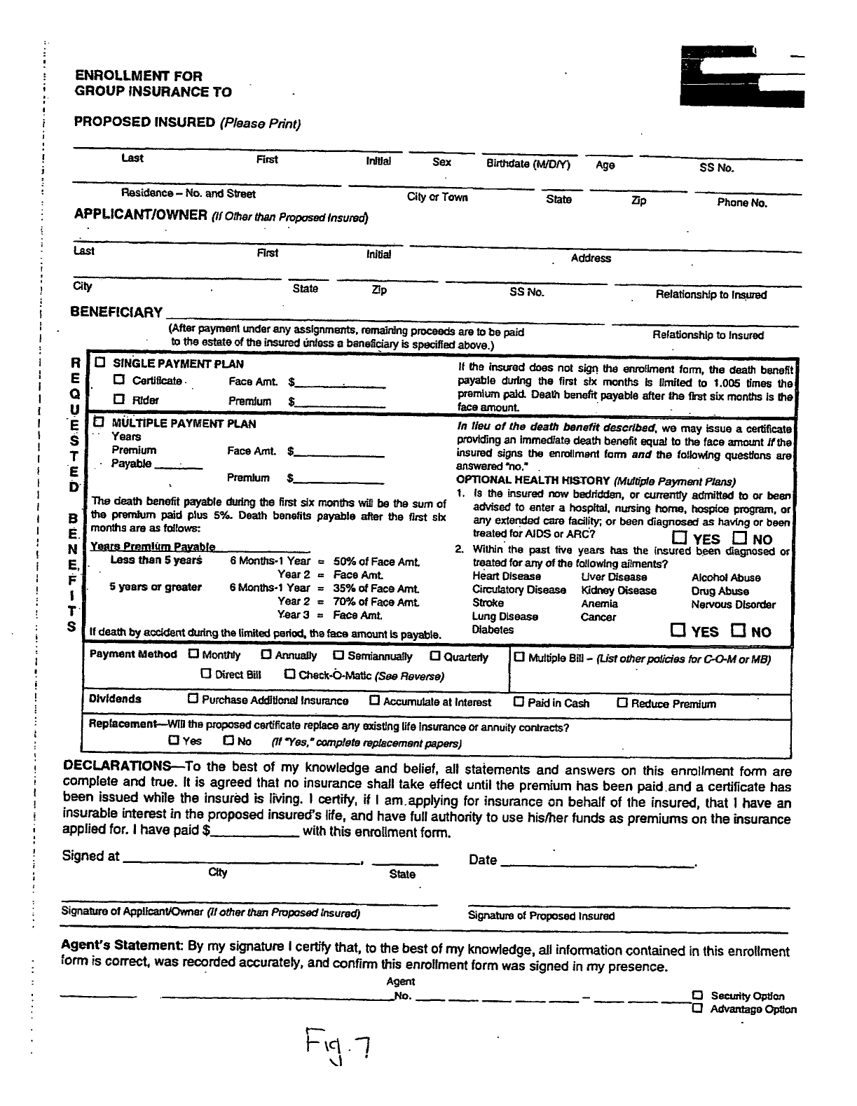

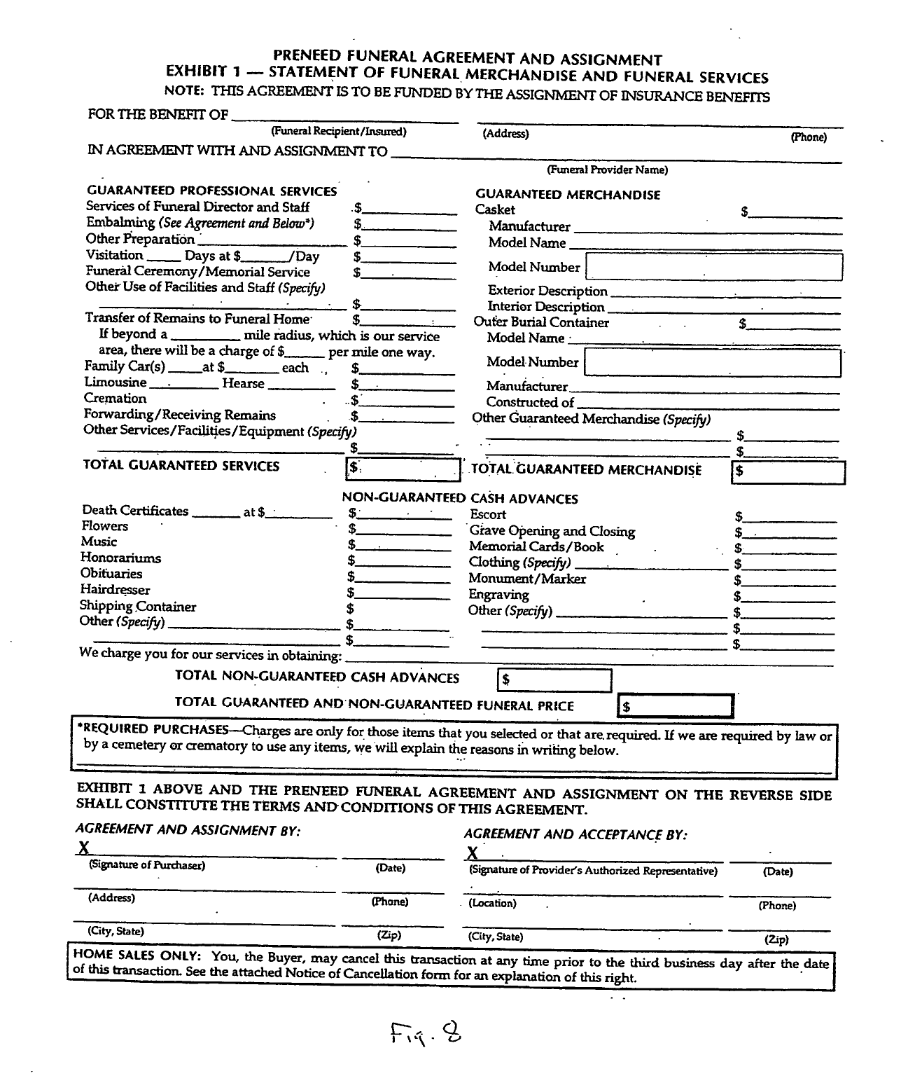

FIGS. 7 and 8 are embodiments of a pre-need enrollment forms.

The present invention still further offers general life insurance policies and programs as a service in conjunction with the pre-need services contracted with a service provider. Additionally, a Social Security module of the present invention enables consumers 100 to pay into Social Security funds for subsequent application, assignment or disbursement toward their service provider. Still other modules of the present invention offer payment into education funds and/or pension funds, as well as trust accounts, all of which may be subsequently transferred, conveyed, assigned or otherwise applied to a named-beneficiary, or further made available for implementation of the selected service or pre-need plans/policies as a service. A pre-need insurance rider will further be offered for long-term health care plans and veteran plans for implementation as a service and service plans. This method can be used in other industries, such as pension, health, education, funeral industries and other industries that this method is useful.

The software techniques and methods discussed are software as service method will be implemented. The software techniques and methods discussed are within alternatives, adaptations, and modifications made within the scope of the present invention are based software techniques and a combination of them, computer hardware, firmware. The software as a service method will be implemented. The customer contracts to use an application, such as ERP or CRM, hosted by a third party. The customer being the consumer and service providers. The enterprise customer access business applications over the internet and customers pay a subscription fee or monthly fee. The product delivery and software applications will be made available online which the combination policy products will be made available to the consumer or thorough the service provider as a contract with the consumer for sale. Apparatus may be implemented in digital electronic circuitry, or in computer hardware, firmware, software, or in combinations of them. Apparatus may be implemented in a computer program product tangibly embodied in a machine-readable storage device for execution by a programmable processor; and methods may be performed by a programmable processor executing a program of instructions to perform functions by operating on input data and generating output.

Also computer program product will be delivered on demand through web applications. Further embodiments may advantageously be implemented in one or more computer programs that are executable on a programmable system including at lease one programmable processor coupled to receive data and instructions from, and transmit data and instructions, to a data storage system, at least one input device, and at lease one output device. Each computer program may be implemented in machine language or assembly language which can be assembled or translated, or a high level procedural or object-oriented programming language, which can be complied or interpreted. Suitable processors include, by way of example, both general and special purpose microprocessors. Generally, a processor receives instructions and data from read-only memory and or RAM.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A method for providing a pre-need funeral services comprising:
Identifying a pre-need subscription and/or service plan customer; providing the pre-need subscription and/or service plan customer access to a pre-need system;
Providing pre-need subscription and/or service plan policy information to the pre-need subscription and/or service plan customer via the pre-need system;
Determining payment for the pre-need subscription and/or service plan policy and
Determining pre-need subscription and/or service plan policy commitment by the pre-need subscription and/or service plan customer with service provider.

2. The method as claimed in claim 1 wherein identifying a pre-need subscription and or service plan customer comprises determining whether the pre-need subscription customer is an existing subscription customer.

3. The method as claimed in claim 1 wherein identifying a pre-need subscription and or service plan customer comprised determining whether the pre-need subscription and/or service plan customer is interested in a pre-need subscription and/or service plan policy.

4. The method as claimed in claim 1 further comprising activating a pre-need subscription and/or service plan account

5. (canceled)

6. (canceled)

7. (canceled)

8. The method as claimed in claim 5 further comprising providing a combination kit to the pre-need subscription and/or service plan customer

9. The method as claimed in claim 8 wherein the combination kit comprises:
the pre-need subscription and or service plan policy and
The pre-need subscription service plan account
Explanation of claim 9: The subscription policy services will be subscribed by consumers and servicing funeral homes for subscription services. The service plans i.e. life, pension, health, education and other transferable plans will be subscribed by consumers as a service with pre-need planning services.

10. The method as claimed in claim 9 wherein the activities related to the pre-need subscription and/or service plan policy comprise purchasing funeral services.

11. The method as claimed in claim 9 wherein the activities related to the pre-need subscription and/or service plan policy comprise purchasing funeral merchandise.

12. The method as claimed in claim 9: The pre-need Subscription and/or service plan policy comprise purchasing a pre-need subscription and/or service plan policy (life, pension, health, education or other transferable plans, funds and account modules)a pre-need insurance policy with a service provider.

13. The method as claimed in claim 1 further comprising collecting demographic data related to the pre-need subscription and/or service plan customer.

14. The method as claimed in claim 13 wherein the demographic date includes personal information related to the pre-need subscription and/or service plan customer.

15. The method as claimed in claim 13 wherein the demographic data includes transferable beneficiary information.

16. The method as claimed in claim 15 wherein a named transferable beneficiary receives a remaining balance once pre-need subscription services are complete by servicing funeral home upon the death of the pre-need subscription and/or service plan customer.

17. The method as claimed in claim 13 wherein the demographic data includes living will information related to the pre-need subscription and/or service plan customer.

18. The method as claimed in claim 1 further comprising identifying an insurance service plan policy to be used for funding the pre- need subscription policy.

19. The method as claimed in claim 19 further executing an assignment of benefits related to the insurance service plan policy to fund the pre-need subscription policy for service provider services.

20. A system for providing pre-need funeral services, comprising:
A pre-need funeral and insurance subscription service provider to provide a pre-need subscription service plan and insurance
A pre-need policy subscription service funded by an assignment of the insurance provided by the insurance provider:
A pre-need package subscription service combining the pre-need subscription policy and the insurance as a service plan
A funeral home subscription service to be funded by the pre-need subscription policy holder; and A Merchandise service to be funded by the pre-need subscription policy upon death of a pre-need subscription policy holder

21. The system as claimed in claim 20 further comprising a patient policy holder search subscription service and database for identifying services related to the pre-need subscription service policy/plan.

22. The system as claimed in claim 20 further comprising an educational pre-planning consumer service to provide updated information related to the pre-need subscription service policy/plan.

23. The system as claimed in claim 20 further comprising a consumer service for providing the subscribed pre-need policy-holder Consumer pre-need planning services related to the pre-need subscription service and/or service plan policy.

24. The method as claimed in claim 20 further comprising a payment service for payment of the pre-need subscription service plan policy.

25. The system as claimed in claim 24 wherein the payment service comprises providing a Subscription and or service plan account to the policy-holder and servicing funeral home for payment of related pre-need services and or service plan.

26. (canceled)

27. (canceled)

28. The system as claimed in claim 24 further comprising a certified pre-need insurance agent for providing an insurance policy as a service plan, the benefits of which are assigned to fund the pre-need subscription policy/service plan and

29. The system as claimed in claim 20 further comprising a service website that the policy holder can access pre-need services and service plans related to the subscribed pre-need service plan policy.

30. The system as claimed in claim 20 further comprising a system administrator for oversight of all the pre-need policy and service plan services.

31. A system, comprising:
A pre-need website
A customer service center coupled to the pre-need website;
A customer portal to the pre-need website; and
An administrator portal to the pre-need website.

32. The system as claimed in claim 31 further comprising a funeral services provider portal to the pre-need website.

33. The system as claimed in claim 32 further comprising an insurance agent portal to the pre-need website.

34. The system as claimed in claim 33 further comprising means for directing insurance service plan policy proceeds for use as payment for a pre-need subscription service plan policy.

35. The system as claimed in claim 31 wherein the pre-need website provides access to educational pre-need planning services.

36. A method, comprising:
Choosing desired funeral arrangements;
Identifying a payment plan for the funeral arrangements; and
Identifying a transferable beneficiary to receive an overage of funding for the funeral arrangements.

37. The method as claimed in claim 36 wherein the payment plan is the assignment of pre-need proceeds to servicing funeral home subscriber.

38. The method as claimed in claim 36 wherein the payment plan is the activation of a Subscription/and or service plan account.

39. (canceled)

40. The method as claimed in claim 36 wherein the funeral arrangements are funeral services.

41. The method as claimed in claim 36 wherein the funeral arrangements are funeral merchandise.

42. The method as claimed in claim 36 further comprising choosing a funeral director for making the funeral arrangements.

43. The method as claimed in claim 42 further comprising choosing an insurance agent.

44. The method as claimed in claim 44 further comprising obtaining a pre-need subscription service plan policy and service provider

45. The method as claimed in claim 44 further comprising obtaining a pre-need subscription service plan insurance policy and service provider.

46. The method as claimed in claim 45 further comprising assigning proceeds associated with the pre-need subscription service plan insurance policy to the payment of the pre-need subscription/service plan policy and service provider.
